(19) United States
(12) Patent Application Publication
(10) Pub. No.: US 2008/0242176 A1
(43) Pub. Date: Oct. 2, 2008

(54) Fabric with improved heat resistance and methods of making same

(75) Inventors: Eric M. Jaeger, El Segundo, CA (US); Minho Kim, Kyunggi-do (KR)

Correspondence Address: IRVING KESCHNER, 21535 HAWTHORNE BOULEVARD, SUITE 385, TORRANCE, CA, 90503, US

(73) Assignee: Ironclad Performance Wear Corp.

(21) Appl. No.: 11/731,061

(22) Filed: Mar. 30, 2007

(51) Int. Cl. B32B 27/02; B05D 3/02; B32B 5/02

(52) U.S. Cl. 442/139; 427/387; 442/136; 442/152; 442/164; 442/167; 442/169; 442/59

(57) ABSTRACT

Fabric impregnated with polysiloxane. The fabric may be leather, synthetic leather or suede. Alternatively the fabric may be made from aramid or oxidized polyacrylic/nitride fibers. One method of making this fabric is to mix liquid silicone rubber; impregnate the fabric with the liquid chemical; and heat the fabric at 120-200° C. for 10-150 seconds. Another method of making the fabric is to mix liquid silicone rubber or a mixture of liquid silicone rubber and catalyzed polyurethane with fibers and heat the mixture at 120-200° C. for 10-150 seconds. Fibers may be polyester microfibers, nylon microfibers, suede, aramid, oxidized polyacrylic/nitride, and mixtures of these fibers.

### BACKGROUND OF THE INVENTION

(1) Field of the Invention

The present invention relates to the field of fabrics, and more particularly to fabrics that are treated for heat protection by impregnation with polysiloxane.

(2) Description of the Related Art

A number of heat protected gloves have been available in the prior art. For example, leather gloves having synthetic and natural insulation, knit cotton gloves, oven mitts using cotton or other fiber fabrics with insulation, silicon molded grips and mitts, aluminized coating on cotton, wool, aramid fibers (such as Kelvar® or Nomex®) and racing gloves (combination of cut and sewn aramid fabrics and leather) all have some heat protection features. In some glove applications silicone has been printed or screen printed on the surface of the glove.

U.S. Pat. No. 7,086,092 to Carey et al. discloses a glove having a heat insulating barrier which is removably inserted into a pocket or pouch positioned adjacent the back of a user's hand. The insulating barrier reduces heat conduction from the back side of the hand enabling the user's hand to remain warm in cold environments. The heat insulating barrier is constructed, for example, of closed-cell neoprene with fleece laminated therewith.

U.S. Pat. No. 5,598,582 to Andrews et al. discloses a hand covering in the form of a glove which is water proof and provides protection against cutting, puncturing and lacerations as well as thermal insulation for protection against burning of the user's hand when grasping hot objects. A raised silicone pattern is formed on the palm portion of the glove to enhance the heat insulating and gripping abilities of the hand covering.

U.S. Pat. No. 6,021,523 to Vero discloses a hand covering which is heat and abrasion resistant. The hand covering is processed by utilizing a fabric formed with conditioned KEVLAR wound with a top cover of a yarn selected from the group consisting of PANOX and VECTRAN.

U.S. Pat. No. 7,000,257 to Bevier discloses a structure of a glove that includes a first material element and a second material element. The material elements are separate from each other and positioned adjacent each other, and the material elements are joined with a stitchless configuration, that may be a stitchless seam. An adhesive element may be secured to each of the first material element and the second material element to form the stitchless configuration. The adhesive element may be a polymer, and more particularly, may be a thermoplastic polymer.

U.S. Pat. No. 7,100,212 to Jaeger discloses a fitted glove structure that incorporates a molded rubber palm piece that has a portion which extends over certain of the glove fingertips to the back piece in a manner to increase wearer comfort and protection and to enhance the object pick up capabilities of the glove.

United States Patent Application Publication 2003/0148693 to Erb et al. discloses an insulating fabric which substantially prevents propagation of fire utilizing a blend of modified aluminum oxide-silica fibers and organic fibers in a multi-layer blanket.

Although the prior art glove and fabric constructions noted above provided heat protection, when the glove is intended for work applications certain disadvantages arise. For example, if natural or synthetic material is used as the glove palm material, the following table illustrates the properties associated with each:

| | | Resistance | Dexterity | | | |
|---|---|---|---|---|---|---|
| | | To | After Heat | Abrasion | | |
| Glove Type | Dexterity | Shrinkage | Exposure | Resistance | Durability | Breathability |
| Test Method | EN 420¹, | EN 13844, | EN 420, | EN 388, | | ASTM D737 |
| | ASTM | ASTM | ASTM F210 | ASTM | | |
| | F210² | D6076 | | D3884 | | |
| Leather | Low | Poor | Poor | High | High | Poor |
| Leather Insulated | Low | Poor | Poor | High | High | Poor |
| Cotton Knit | High | High | High | Low | Low | High |
| Oven Mitts | Low | High | High | Low | Low | Low |
| Silicone Molded | Low | High | High | Low | Low | Low |
| Grips And Mitts | | | | | | |
| Aluminum | Low | Moderate | Moderate | Low | Moderate | Low |
| Coated Leather | | | | | | |
| Or Cotton | | | | | | |
| Aramid Knits | High | High | High | Low | Low | High |
| (Nomex ®, | | | | | | |
| Kevlar ®) | | | | | | |
| O-PAN Knit | High | High | High | Low | Low | High |
| (Oxidized | | | | | | |
| Polyacrylic | | | | | | |
| Nitride) | | | | | | |
| Racing | High | Poor | Poor | Low | Moderate | Moderate |
| Gloves | | | | | | |
| (Leather And | | | | | | |
| Aramid) | | | | | | |

| | Dexterity | | Contact | Convective | | |
|---|---|---|---|---|---|---|
| | after | Flame | Heat | Heat | Splash | |
| Glove Type | Washing | Protection | Protection | Protection | Protection | Grip |
| Test Method | EN 420, | EN 407, | EN 407, | EN 407 | ISO | ASTM |
| | ASTM | ASTM | ASTM | | 13994³ | D6183 |
| | F210 | F1358 | F1060 | | | |
| Leather | Low | Moderate | Good | Good | High | High |
| Leather Insulated | Low | Moderate | High | High | High | Good |
| Cotton Knit | High | Low | Low To | Low | Low | Low |
| | | | Moderate | | | |
| Oven Mitts | Low | Low | High | High | High | Low |
| Silicone Molded | Low | Good | Good | Good | High | Good |
| Grips And Mitts | | | | | | |
| Aluminum Coated | Low | Moderate | High | High | High | Low |
| Leather Or Cotton | | | | | | |
| Aramid Knits | High | High | Good | Low | Low | Low |
| (Nomex ®, | | | | | | |
| Kevlar ®) | | | | | | |
| O-PAN Knit | | | | | | |
| (Oxidized | High | High | Good | Low | Low | Low |
| Polyacrylic Nitride) | | | | | | |
| Racing Gloves | Low | High | Moderate | Low to | Low | High |
| (Leather And | | | | Moderate | | |
| Aramid) | | | | | | |

¹EN standards are controlled by CEN, the European Committee for Standardization, Brussels, Belgium.
²ASTM standards are controlled by ASTM International, West Conshohocken, PA.
³ISO standards are controlled by the International Organization for Standardization, Geneva, Switzerland.

Development of a fabric with improved heat resistance represents a great improvement in the field of fabrics and satisfies a long felt need of clothing and equipment manufacturers.

What would be desired is to provide a glove palm material which is heat resistant and which has as many as possible of the desirable characteristics and properties noted in the table above.

### SUMMARY OF THE INVENTION

The present invention is fabric impregnated with polysiloxane which imparts improved heat resistance properties. While most useful for glove construction the instant invention can be used in any application where heat resistance is important.

The fabric may be synthetic leather, leather or suede. Alternatively the fabric may be made from aramid or oxidized polyacrylic nitride fibers. The polysiloxane penetrates from 5 to 50% of the fabric thickness as measured from the surface of the fabric. Penetration may be accomplished from one or both surfaces of the fabric. The polysiloxane comprises from 5 to 75% of total material weight. This process may be used to penetrate woven, knitted, non-woven fabric and compressed non-woven fabric.

One method of making this fabric is to obtain a liquid, two component silicone rubber; mix the two components in a ratio designed to cause curing, impregnate the surface of the fabric with the mixture; and heat the fabric at 120-200° C. for 10-150 seconds.

Another method of making the fabric is to obtain a liquid, two component silicone rubber; mix the two components in a ratio designed to cause curing, mix this mixture with fibers and heat the mixture at 120-200° C. for 10-150 seconds. Fibers may be polyester microfibers, nylon microfibers, aramid and oxidized polyacrylic/nitride, and mixtures of these fibers.

A third method of making the fabric is to obtain a liquid, two component 5 silicone rubber; mix the two components in a ratio designed to cause curing, mix this mixture with fibers and catalyzed polyurethane and heat the mixture at 120-200° C. for 10-150 seconds. Fibers may be polyester microfibers, nylon microfibers, suede, aramid and oxidized polyacrylic/nitride, and mixtures of these fibers.

If used in glove construction, at least the palm portion of the glove is fabricated from heat resistant material in accordance with this invention. Preferably, the uncured silicone rubber mixture is applied to synthetic leather and then heated for a period of time. The uncured silicone rubber mixture penetrates the fabric from one or both surfaces and then polymerizes. This results in a chemically cross linked elastomeric solid within the body of the fabric. The impregnated material is then cut into a pattern which corresponds to a glove palm piece. The glove is then fabricated by sewing the palm piece to a glove back piece in a conventional manner. The resultant glove is heat protected yet has the dexterity of a non heat protected glove. Protrusions may be formed on the glove surface to provide for additional heat protection. An example of protrusions that may be utilized is shown in U.S. Pat. No. 5,598,582. Alternatively, the protrusions may produce a nubby surface.

Gloves made with the material of this invention have a smooth surface and increased grip (i.e. frictional properties) and are visually pleasing. The following chart compares their properties to those of other materials in more detail.

| | | Low | | Stays | | | | |
|---|---|---|---|---|---|---|---|---|
| | | Shrinkage | Durable | Flexible | | High | | |
| | High | After | After | After | High | Durability | | |
| | Glove | Heat | Heat | Heat | Abrasion | For Working | Good Vapor | |
| Material | Dexterity | Exposure | Exposure | Exposure | Resistance | Applications | Transmission | Washable |
| Natural | No | No | Yes | No | Yes | Yes | No | No |
| Leather | | | | | | | | |
| Synthetic | Yes | Yes | No | No | Yes | Yes | Yes | Yes |
| Leather | | | | | | | | |
| Instant | Yes | Yes | Yes | Yes | Yes | Yes | Yes | Yes |
| Invention | | | | | | | | |

| | | Low | | | | | |
|---|---|---|---|---|---|---|---|
| | Resists | Duration, | Moderate | Moderate | | | |
| | Melting | Low Temp | Convective | Conductive | Adaptable To | Good | |
| | after Heat | Flame | Heat | Heat | Many Styles, | Splash | Good |
| Material | Exposure | Protection | Protection | Protection | Configurations | Protection | Grip |
| Natural | Yes | Yes | Yes | Yes | Yes | Yes | No |
| Leather | | | | | | | |
| Synthetic | No | No | Yes | No | Yes | Yes | Yes |
| Leather | | | | | | | |
| Instant | Yes | Yes | Yes | Yes | Yes | Yes | Yes |
| Invention | | | | | | | |

An appreciation of the other aims and objectives of the present invention and an understanding of it may be achieved by referring to the accompanying description of a preferred embodiment.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

For purposes of clarification, a polyurethane is any polymer consisting of a chain of organic units joined by urethane links. It is widely used in flexible and rigid foams, durable elastomers, high performance adhesives and sealants, fibers, seals, gaskets, condoms, carpet underlay, and hard plastic parts. Polyurethane products are often called “urethanes”. They should not be confused with the specific substance urethane, also known as ethyl carbamate. Polyurethanes are not produced from ethyl carbamate, nor do they contain it.

The main polyurethane producing reaction is between a diisocyanate (aromatic or aliphatic) and a polyol, typically a polyethylene glycol or polyester polyol, in the presence of catalysts and surfactants. In the case of foams materials for controlling the cell structure are also added. Polyurethane can be made in a variety of densities and hardnesses by varying the type of monomer(s) used and adding other substances to modify their characteristics, notably density, or enhance their performance. Other additives can be used to improve the fire performance, stability in difficult chemical environments and other properties of the polyurethane products.

Though the properties of the polyurethane are determined mainly by the choice of polyol, the diisocyanate exerts some influence. The cure rate is influenced by the functional group reactivity and the number of functional isocyanate groups. Mechanical properties are influenced by the functionality and the molecular shape. The choice of diisocyanate also affects the stability of the polyurethane upon exposure to light. Polyurethanes made with aromatic diisocyanates yellow with exposure to light, whereas those made with aliphatic diisocyanates are stable.

Softer, more elastic, and more flexible polyurethanes result when linear difunctional polyethylene glycol segments, commonly called polyether polyols, are used to create the urethane links. This strategy is used to make spandex elastomeric fibers and soft rubber parts, as well as foam rubber. More rigid products result if polyfunctional polyols are used, as these create a three-dimensional cross-linked structure which, again, can be in the form of a low-density foam.

Two part polyurethanes, one containing the diisocyanate and the other containing the polyol, are available commercially. The parts are mixed in the correct proportions to produce a catalyzed mixture which then cross links or cures usually with application of heat.

For purposes of clarification a silicone or siloxane is any of the class of compounds containing the structural unit R₂SiO, where R is an organic group or hydrogen. Polysiloxanes are polymers with the chemical formula [R₂SiO]ₙ. Aramid is a long-chain synthetic polyamide in which at least 85% of the amide linkages (—CO—NH—) are attached directly to two aromatic rings. Polyesters are condensation polymers, which contain the ester functional group in their main chain. Two of the most important synthetic polyesters are polycarbonates and polyethylene terephthalate (PET). Microfiber is fiber with strands less than one denier⁴. 4 A denier is a unit of weight indicating the fineness of fiber filaments and yarns and is equal to one gram per 9000 meters.

According to ASTM D1418 there are various classes of silicone rubbers. These are outlined in the following table.

| Class | Description | Application |
|---|---|---|
| MQ | Silicone rubbers having only methyl | Not commonly used |
| | groups on the polymer chain | |
| | (polydimethyl siloxanes) | |
| VMQ | Silicone rubbers having methyl and vinyl | General purpose |
| | substitutions on the polymer chain | |
| PMQ | Silicone rubbers having methyl and | Extremely low |
| | phenyl substitutions on the polymer chain | temperature |
| | | applications |
| | | Not commonly used |
| PVMQ | Silicone rubbers having methyl, phenyl | Extremely low |
| | and vinyl substitutions on the polymer | temperature |
| | chain | applications |
| FVMQ | Silicone rubbers having fluoro, methyl | Applications |
| | and vinyl substitutions on the polymer | involving fuel, oil |
| | chain | and solvent |
| | | resistance. |

There are three main industrial classifications of silicone rubbers:

High Temperature Vulcanizing (HTV)—Sometimes called heat curable, these are usually in a semi-solid gum form in the uncured state. They require rubber-type processing to produce finished items.

Room Temperature Vulcanizing (RTV)—Usually come as a flowable liquid and are used for sealants, mould making, encapsulation and potting. These materials are not generally used as conventional rubbers.

Liquid Silicone Rubbers (LSR)—Sometimes called heat curable liquid materials, these materials are processed on specially designed injection molding and extrusion production equipment.

The most common method for preparing silicone precursors involves reacting a chlorosilane with water. This produces a hydroxyl intermediate, which condenses to form a polymer-type structure. The basic reaction sequence is represented as:

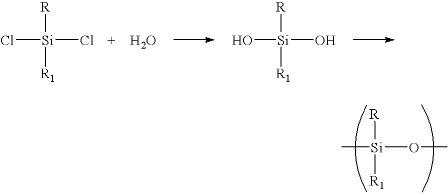

This is the favored route although other raw materials such as alkoxysilanes can be used. Chlorosilanes and other silicone precursors are synthesized using the “Direct Process”, involving the reaction of elemental silicone with an alkyl halide thus,

Si+RX→RₙSiX₄₋ₙ (where n=0-4)

Preparation of silicone rubbers requires the formation of high molecular weight (generally greater than 500000 g/mol). To produce these types of materials requires di-functional precursors, which form linear polymer structures. Mono and tri-functional precursors form terminal structures and branched structures respectively.

With the exception of RTV and liquid curing systems, silicone rubbers are usually cured using peroxides such as benzoyl peroxide, 2,4-dichlorobenzoyl peroxide, t-butyl perbenzoate and dicumyl peroxide. Alkyl hydroperoxides and dialkyl peroxides have also been used successfully with vinyl containing silicones. Platinum containing catalysts are used in medical applications.

Hydrosilylation or hydrosilation is an alternative curing method for vinyl containing silicones and utilizes hydrosilane materials and platinum containing compounds for catalysts. It is a 2-part process requiring mixing of 2 separate components, with the resulting material having a limited shelf life. Curing does not produce volatiles and heat cured conventional silicones with high tear strengths can be cured in this way.

Reinforcing fillers are added to improve the otherwise poor tensile strength of silicones. Silica, in the form of silica fume with particle sizes in the range 10-40 nm is the most preferred filler, although carbon black has been used. Fillers do interact with the vulcanizate, forming a pseudo-vulcanization. This can occur either during mixing (creep hardening) or in storage (bin ageing).

Although milling can break down these structures, it is also common to add structure control additives to combat these reactions. Examples of these materials are siloxane-based compounds such as diphenylsilane and pinacoxydimethylsilane.

Silicones have better fire resistant properties than natural rubbers. This property can be improved by the addition flame retardant additives such as platinum compounds, carbon black, aluminum trihydrate, antimony compounds, zinc compounds or ceric compounds. Further improvement in fire resistance may be achieved by incorporating chlorine functional groups on the polymer chain. It should be noted that carbon black addition also increases electrical conductivity.

Ferric oxide may also be added to improve heat stability. Titanium dioxide and other organometallic compounds are used as pigments.

Liquid silicone rubbers are two-part systems, supplied deaerated ready for use. Precursors are in one part and curing agents are in the other. They cure into a polysiloxane after mixing the two separate portions. Curing is often complete in as little as a few seconds at temperatures of about 200° C. and post-curing is not usually required. Varying the ratio of precursor to curing agent varies the viscosity of the mixed liquid.

The process of this invention can be applied to any woven or non woven fabric including commercial synthetic leather and suede. Synthetic leather is a compressed, non-woven fabric made of polyester or nylon microfibers in a binder, which is typically polyurethane. The ratio of fiber to binder ranges from 60/40 to 80/20. The synthetic leather can be dyed or otherwise surface treated.

The viscosity of the mixed liquid silicone rubber is adjusted to ensure proper penetration into the fabric. This can be achieved by adjusting the ratio of precursor to curing agent. Alternatively or additionally viscosity can be adjusted by addition of a thinner, such as heptane, acetone, or alcohol. The mixed or catalyzed liquid silicone rubber is spread onto one or both surfaces of the fabric. The mixed silicone rubber is then allowed to penetrate into the fabric. Methods such us squeegeeing through a screen have been found helpful in controlling the amount of silicone rubber applied to a surface. Next the treated fabric is heated at 120-200° C. for 10-150 seconds which causes the liquid silicone rubber to cure into polysiloxane. This results in a cross linked elastomer matrix within the fabric.

Other methods of introducing mixed, liquid silicone rubber into woven or non-woven fabric are of course possible, including introduction of mixed silicone rubber during the original manufacture of the fabric. In this case the typical polyurethane binder of synthetic leather is replaced completely or partially with mixed, liquid silicone rubber.

The desired result is penetration of the polysiloxane into the fabric, not layering of the polysiloxane on top of the fabric. Polysiloxane penetration into surface from either side is 5 to 50 percent of total material thickness. Resulting concentration by weight is 5 to 75 percent of total material weight. This represents an addition of 5 to 300 percent by weight of fabric before impregnation.

If the polysiloxane is layered on top of the fabric this will result in loss of breathability, poor grip on wet surfaces and lower heat durability. Also the fabric underneath will melt and stiffen after heat exposure. If the polysiloxane does not penetrate well into the fabric this will result in lower heat durability.

### EXAMPLE

A piece of synthetic leather was impregnated with polysiloxane using the process of this invention. The liquid silicone rubber used was SJS-2002, supplied by Sejin Silicone Co. Ltd. Samples were cut from the impregnated fabric with a sharp surgical blade and coated with gold-palladium to prevent charging. The samples were subjected to scanning electro-microscopic examination. It was found that the polysiloxane had penetrated into the fabric 9.9 to 24.1 percent of the fabric thickness as measured from the surface.

It was also found that the concentration by weight of polysiloxane was 28-29 percent. This represents an increase of 39-41 percent by weight over the weight of the fabric before impregnation. The impregnated sample had the following properties:

| | Low | | Stays | | | | |
|---|---|---|---|---|---|---|---|
| High | Shrinkage | Durable | Flexible | High | High Durability | | |
| Glove | After Heat | After Heat | After Heat | Abrasion | For Working | Good | |
| Dexterity | Exposure | Exposure | Exposure | Resistance | Application | Breathability | Washable |
| Yes | Yes | Yes | Yes | Yes | Yes | Yes | Yes |

| | Low Duration | | | | | |
|---|---|---|---|---|---|---|
| High Heat | Low Temp | Moderate | Moderate | Adaptable To Many | | |
| Flame | Flame | Convective | Radiant Heat | Styles, | Good Splash | Good |
| Protection | Protection | Heat Protection | Protection | Configurations | Protection | Grip |
| No | Yes | Yes | Yes | Yes | Yes | Yes |

Test methods used included ASTM F1790 (Cut Protection Performance, ASTM F1060 (Thermal Protective Performance), ASTM F1358 (Flame Impingement), and a modified version of ASTM F1060 (Thermal Protection at Various Temperatures).

Thus, the present invention has been described herein with reference to particular embodiments for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A material with improved heat resisting properties comprising a fabric impregnated with a polysiloxane.

2. The material of claim 1 in which said polysiloxane includes a flame retardant.

3. The material of claim 2 in which said flame retardant is selected from the group consisting of platinum compounds, carbon black, aluminum trihydrate, antimony compounds, zinc compounds, ceric compounds, and mixtures thereof.

4. The material of claim 1 in which said fabric is selected from the group consisting of leather, synthetic leather and suede.

5. The material of claim 1 in which said fabric is selected from the group consisting of woven, non-woven, knitted and compressed non-woven.

6. The material of claim 1 in which said fabric is made from fibers selected from the group consisting of aramid and oxidized polyacrylic nitride.

7. The material of claim 1 in which said polysiloxane penetrates from 5 to 50% of the fabric thickness as measured from a surface of said fabric.

8. The material of claim 1 in which said polysiloxane comprises from 5 to 75% of total material weight.

9. A material with improved heat resisting properties comprising a fabric impregnated with a polysiloxane and a polyurethane.

10. The material of claim 9 in which said polysiloxane includes a flame retardant.

11. The material of claim 10 in which said flame retardant is selected from the group consisting of platinum compounds, carbon black, aluminum trihydrate, antimony compounds, zinc compounds, ceric compounds, and mixtures thereof.

12. The material of claim 9 in which said fibers are selected from the group consisting of polyester microfibers, nylon microfibers, aramid, oxidized polyacrylic nitride, and mixtures thereof.

13. The material of claim 9 in which said polysiloxane penetrates from 5 to 50% of the fabric thickness as measured from a surface of said fabric.

14. The material of claim 9 in which said polysiloxane comprises from 5 to 75% of total material weight.

15. A method of providing a fabric with improved heat resistance comprising the steps of:
a) obtaining a liquid, two component silicone rubber;
b) mixing said components in a ratio calculated to cause curing of said silicone rubber;
c) impregnating a surface of said fabric with said mixture; and
d) heating said fabric at 120-200° C. for 10-150 seconds.

16. The method of claim 15 further comprising the step of adding a flame retardant to said silicone rubber.

17. The method of claim 16 in which said flame retardant is selected from the group consisting of platinum compounds, carbon black, aluminum trihydrate, antimony compounds, zinc compounds, ceric compounds, and mixtures thereof.

18. The method as claimed in claim 15 in which said fabric is selected from the group consisting of leather, synthetic leather and suede.

19. The method as claimed in claim 15 in which said fabric is selected from the group consisting of woven, non-woven, knitted and compressed non-woven.

20. The method as claimed in claim 15 in which said fabric is made from fibers selected from the group consisting of aramid and oxidized polyacrylicnitride.

21. The method of claim 15 in which said silicone rubber penetrates from 5 to 50% of the fabric thickness as measured from a surface of said fabric.

22. The method of claim 15 in which said silicone rubber comprises from 5 to 75% of total material weight.

23. A method of fabricating a fabric with improved heat resistance comprising the steps of:
a) obtaining liquid, two component silicone rubber;
b) obtaining fabric fibers;
c) mixing said components in a ratio calculated to cause full vulcanization of said silicone rubber;
d) mixing said fabric fibers with said mixture; and
e) heating said mixture at 120-200° C. for 10-150 seconds;
whereby said silicone rubber cross links.

24. The method of claim 23 further comprising the step of adding a flame retardant to said silicone rubber.

25. The method of claim 24 in which said flame retardant is selected from the group consisting of platinum compounds, carbon black, aluminum trihydrate, antimony compounds, zinc compounds, ceric compounds, and mixtures thereof.

26. The method as claimed in claim 23 in which said fibers are selected from the group consisting of polyester microfibers, nylon microfibers, suede, aramid, oxidized polyacrylic nitride, and mixtures thereof.

27. A method of fabricating a fabric with improved heat resistance comprising the steps of:
a) obtaining liquid, two component silicone rubber;
b) obtaining two part polyurethane;
c) obtaining fabric fibers;
d) mixing said components in a ratio calculated to cause full vulcanization of said silicone rubber;
e) mixing said parts in a ratio designed to cause full curing of said polyurethane;
f) mixing said fabric fibers with said mixed components and said mixed parts; and
g) heating said mixture at 120-200° C. for 10-150 seconds;
whereby said silicone rubber and said polyurethane cross link.

28. The method of claim 27 further comprising the step of adding a flame retardant to said silicone rubber.

29. The method of claim 28 in which said flame retardant is selected from the group consisting of platinum compounds, carbon black, aluminum trihydrate, antimony compounds, zinc compounds, ceric compounds, and mixtures thereof.

30. The method as claimed in claim 27 in which said fibers are selected from the group consisting of polyester microfibers, nylon microfibers, suede, aramid, oxidized polyacrylic nitride, and mixtures thereof.
